(19) United States
(12) Patent Application Publication
(10) Pub. No.: US 2009/0139978 A1
(43) Pub. Date: Jun. 4, 2009

(54) WATER/POWDERED MILK MIXING DEVICE FOR NURSING

(76) Inventor: Chong-Kyu Ha, Seoul (KR)

Correspondence Address: IPLA P.A., 3580 WILSHIRE BLVD., 17TH FLOOR, LOS ANGELES, CA, 90010, US

(21) Appl. No.: 12/063,624

(22) PCT Filed: Aug. 11, 2006
(86) PCT No.: PCT/KR2006/003171

§ 371 Date: Feb. 12, 2008

(30) Foreign Application Priority Data
Aug. 12, 2005 (KR) 20-2005-0023352
Jul. 4, 2006 (KR) 20-2006-0018029

(51) Int. Cl. F27D 11/00; A47J 31/00; B67D 5/62

(52) U.S. Cl. 219/441; 392/442; 222/146.5

(57) ABSTRACT

Disclosed herein is a water/powdered milk mixing device, capable of mixing water and powdered milk, which are independently stored, at a predetermined concentration when a mixing switch is manipulated. The device has a water heating means (11) for heating water stored in a water storage container. The water heating means and a temperature sensor are controlled by a control unit (50). A predetermined amount of water is dispensed from the water storage container using a water supply pump, and the driving speed of a powdered-milk dispensing means (21) is controlled so that an amount of powdered milk corresponding to the concentration set using a concentration-control-switch is continuously dispensed to a powdered-milk outlet (22). Further, a mixing switch (40) is provided to control the ON/OFF operation of a water supply pump and the powdered-milk dispensing means, thus allowing a user to set the dispensed amount of mixed milk as desired.

### TECHNICAL FIELD

The present invention relates, in general, to a water/powdered milk mixing device, capable of mixing water and powdered milk, which are independently stored, in a pre-determined concentration by manipulating a mixing switch and, more particularly, to a practical water/powdered milk mixing device, which is capable of providing milk for a baby immediately when it wants to drink, which dramatically improves sanitation so as to be highly reliable for parents, and which has a simple structure, thus reducing the manufacturing cost and thereby allowing a consumer to purchase the device at a low cost.

A newborn infant needs a certain nursing period after its birth. Mother's milk may be given to a baby, but milk obtained by mixing powdered milk with hot water is also frequently given to a baby. In order to make milk for a baby, clean lukewarm water at the proper temperature, is prepared. Further, a proper amount of powdered milk is put into a baby bottle using a spoon, and is combined with the water. After the baby bottle containing the powdered milk and the water is shaken, the milk is fed to a baby. However, it is very complicated to repeat the process. Further, since it takes a long time to warm the milk to the proper temperature and mix the powdered milk with water, it is difficult to make the milk immediately when a baby cries because it is hungry.

Therefore, many devices have been invented to automate the process, but are not widely used, because the devices according to the inventions do not satisfy the following requirements.

First, the devices do not give immediate results, that is, they cannot make milk immediately when a baby wants milk. For example, according to Korean Patent Laid-Open Publication No. 2001-0086919, which was published on Sep. 15, 2001, powdered milk is mixed with water and thereafter is warmed up. However, this method does not satisfy the requirement for immediacy, because it takes a long time to warm the milk.

Second, the devices have poor sanitation. The conventional devices are used for babies, who are vulnerable to microorganisms and viruses. The water temperature which is suitable for making milk for babies is 36° C. to 40° C., that is, lukewarm. However, microorganisms propagate rapidly at this temperature, and thus the devices are insanitary when they are left for a lengthy period of time. The milk made by mixing nutritious powdered milk with water is susceptible to the propagation of the microorganisms, so that it is not easy to keep it sanitary.

Third, the devices must be economical. That is, if a nursing device is excessively complicated in structure, the manufacturing cost is increased, thus increasing the burden on consumers. Thus, a simple nursing device is required to provide high productivity and economic efficiency.

Fourth, the devices must be convenient. That is, a nursing device must be constructed so that it is convenient to adjust the concentration of milk and feed milk to a baby at night, and so that it is easy to wash and check the amount fed to the baby. In other words, the nursing device must consider the viewpoints of parents who bring up a baby, and must be sufficiently convenient.

### BACKGROUND ART

In consideration of the above-mentioned requirements, the problems of conventional nursing devices and devices related to feeding will be described below in detail. In the case of the nursing devices which are proposed in Korean U.M. Laid-Open Publication No. 1991-0009101 (Jun. 28, 1991), Korean Patent Laid-Open Publication No. 1994-0013434 (Jul. 15, 1994), Korean Patent Laid-Open Publication No. 1997-0019991 (May 28, 1997), and Korean Patent Laid-Open Publication No. 2002-0085304 (Nov. 16, 2002), the nursing devices maintain the lukewarm temperature of water so as to make feeding milk immediately. However, the nursing devices cannot prevent the propagation of microorganisms or viruses.

Further, in the case of the nursing devices which are proposed in Korean Patent Laid-Open Publication No. 1996-0003702 (Feb. 23, 1996), and Korean Patent Laid-Open Publication No. 1997-0020081 (May 28, 1997), water is boiled in each device so as to provide good sanitation. Thereafter, the water is forcibly cooled using a radiator for indirect contact with cold water or a cooling fan. However, the method is problematic in that it takes a long time to cool the water. Further, the water is heated and then cooled, and thus a lot of energy is wasted, and the device is complicated, so that the manufacturing cost is increased. Moreover, after the elapse of a predetermined time, microorganisms may live in the water even though the water has been boiled. Thus, the devices are still insanitary.

In order to solve the problems, a method of mixing hot water with cold water is used, which is disclosed in Korean Patent Laid-Open Publication No. 2001-0095768 (Nov. 7, 2001). The device according to the patent is complicated in construction, so that the manufacturing cost is increased. Further, microorganisms can easily propagate in cold water, that is, water having a normal temperature, and thus the device is still insanitary.

Further, in order to solve the problems, Korean U.M. Registration No. 0270107 (Mar. 18, 2002) and No. 0387449 (Jun. 10, 2005) were proposed. Each of the devices has an additional water purifier. However, each of the devices is problematic in that it has complicated construction, so that the manufacturing cost is high. In the case of heating purified water, microorganisms may propagate in the water as described above.

Meanwhile, water heating and heat insulating devices related to feeding, such as an ultraviolet sterilizing lamp, are disclosed in Korean U.M. Laid-Open Publication No. 1999-0011844 (Mar. 25, 1999) and Korean U.M. Registration No. 020908 (Oct. 20, 2000). The devices are problematic in that lukewarm water is heated by the ultraviolet sterilizing lamp, so that it is difficult to maintain the temperature of the lukewarm water.

Another water heating and heat insulating device is disclosed in U.S. Pat. No. 6,766,106, which proposes a heat insulating device having the shape of a water dispenser for making baby milk. According to the cited document, a UV sterilizing lamp is attached to the interior of a water tank or a discharge pipe so as to keep it sanitary. The device has various filters for filtering water. However, the device effectively includes a water purifying device for baby milk. Currently, many homes have purifying devices or use spring water, which is sold on the the market, as drinking water. In this regard, the device is complicated and impractical.

A sanitation problem frequently occurs in an area where powdered milk is mixed with water. Most of the inventions have a mixing container for mixing powdered milk with water or a slide pipe along which powdered milk and water flow to be mixed with each other. The construction is the same as a vending machine which sells hot coffee or tea for adults. However, since a water/powdered milk mixing device, which is used for babies and makes lukewarm milk, must be more sanitary, the mixing container or slide pipe stained with milk must be washed every time a baby is fed. The washing operation is inconvenient for parents, so that the device is impractical.

Next, a reduction in the manufacturing cost is required. In relation to the reduction in the manufacturing cost, the adjustment of the mixing ratio (concentration) of water to powdered milk according to the variation in the amount of milk is important. In the case of the vending machine, the amount of coffee put into a cup is fixed. In such a state, a predetermined amount of powder and water are put into the cup, and thus it is relatively simple to adjust the concentration. However, the amount of milk which is to be fed to a baby must be changed depending on the condition of the baby, how hungry it is, the moon's age, etc. Thus, it is not easy to adjust the amount of milk as desired while maintaining a constant concentration.

To this end, the dispensed amount of powdered milk and water must be constant. The dispensed amount of powdered milk can be easily adjusted and kept constant in a dispensing method using a screw, which is implemented in a general vending machine. However, in order to keep the dispensed amount of water constant, it is important to be able to adjust the pressure of water falling into a baby bottle. When using the natural pressure of water which is falling downwards from a water tank, as in Korean U.M. Laid-Open Publication No. 1991-0009101 (Jun. 28, 1991), the amount of water dispensed per hour is reduced, as the amount of water stored in the water tank is reduced.

In order to solve the problem, Korean Patent Laid-Open Publication No. 1997-0019991 (May 28, 1997) and Korean U.M. Registration No. 0387449 (Jun. 10, 2005) compensate for water pressure, using a method of attaching a balance weight to a water tank to adjust the height of the water tank, and a method of adopting a pressure compensating pump, respectively. The devices are complicated and expensive, and are thus impractical.

Further, the concentration of milk must be kept constant even if the amount of milk that is mixed is increased or reduced. To this end, Korean U.M. Laid-Open Publication No. 1991-0009101 (Jun. 28, 1991) requires handling of the amount of powdered milk and the amount of water through a mechanical method which is similar to manual operation, and thus is inconvenient. Meanwhile, according to Korean Patent Laid-Open Publication No. 1994-0013434 (Jul. 15, 1994), No. 1996-0003702 (Feb. 23, 1996), No. 1997-0019991 (May 28, 1997), No. 2003-0021422 (Mar. 15, 2003), and No. 2004-0087607 (Oct. 14, 2004), the amount of powdered milk and water dropping into a baby bottle is electronically calculated using a microprocessor. Thereafter, the opening of a powdered-milk container valve and a water-tank valve is controlled according to the calculated result. This increases the manufacturing cost and is impractical.

For high economic efficiency, the other important factor is a stirring device. Most of the devices include a stirring device for stirring powdered milk with water. The stirring device needs several components, including a motor, in order to hold and shake a baby bottle. Thus, the device is excessively large in consideration of its usefulness, so that the manufacturing cost is increased and the device is impractical.

### DISCLOSURE OF INVENTION

### Technical Problem

Accordingly, the present invention has been made keeping in mind the above problems occurring in the prior art, and an object of the present invention is to provide a practical water/powdered milk mixing device, which minimizes the waiting time required to heat water, thus realizing immediacy so that milk can be immediately fed to a baby, and prevents germs from propagating in the device, thus being sanitary and having a simple construction, therefore increasing productivity.

Another object of the present invention is to provide a portable water/powdered milk mixing device, to which a convenient function, which is indirectly helpful in feeding a baby, has been added, thus being highly convenient for users.

### Technical Solution

In order to accomplish the objects, the present invention provides a water/powdered milk mixing device having a water storage container 10 and a powdered-milk storage container 20 in one casing 100, having water heating means 11 in the water storage container for heating water W stored in the water storage container, and mixing the water with powdered milk, wherein the water heating means 11 and a temperature sensor 14, controlled by a control unit 50, heat the water in the water storage container 10 to a temperature suitable for feeding a baby, a powdered-milk dispensing means 21 is mounted to the powdered-milk storage container 20 to continuously dispense the powdered milk P to a powdered-milk outlet 22, a water supply pump 15 is provided on a water line 13 for connecting the water storage container 10 to a water outlet 12, the powdered-milk outlet 22 and the water outlet 12 are provided on an outer portion of the casing 100 such that the powdered-milk outlet and the water outlet are spaced apart from each other but are adjacent to each other, a sterilizing lamp is installed in the water line or the water storage container 10 to sterilize the water stored in the water storage container 10, and a mixing switch 40 is provided to control the ON/OFF operation of the water supply pump 15 and the powdered-milk dispensing means 21, thus allowing a user to determine a dispensed amount of mixed milk as desired, in the state where a constant mixing concentration is maintained when the water and the powdered milk are continuously mixed with each other.

The powdered-milk dispensing means 21 is mounted to the lower portion of the powdered-milk storage container 20, and continuously drops powdered milk to the powdered-milk outlet 22. The powdered-milk dispensing means 21 uses, for example, a screw feeding device, thus allowing powdered milk to be continuously dispensed.

### Advantageous Effects

As described above, first, the present invention realizes immediacy. That is, the invention always keeps the temperature of water constant, thus immediately providing the desired amount of milk when a baby wants milk and a button is pushed. Second, the invention is sanitary. That is, the invention is provided with an ultraviolet lamp which sterilizes water through an instantaneous sterilizing method, and does not have an additional milk mixing part which must be cleaned, thus allowing milk to be sanitarily supplied. Third, the present invention retains the function of controlling the amount, temperature, and concentration of milk to be fed to a baby, and a stirring function, and in addition, has a simple structure, thus increasing productivity.

Especially, the present invention adds convenient functions which are indirectly helpful in feeding a baby, thus enhancing usefulness.

The water/powdered milk mixing device of the present invention is convenient to a user, is healthy for a baby, and maximizes productivity for a manufacturer, so that the present invention has high industrial applicability.

### BRIEF DESCRIPTION OF THE DRAWINGS

FIG. 1 is a front view showing the external appearance of a casing of a water/ powdered milk mixing device, according to the first embodiment of the present invention;

FIG. 2 is a sectional view illustrating the interior of the water/powdered milk mixing device, according to the first embodiment of the present invention;

FIG. 3 is a sectional view illustrating the interior of a water/powdered milk mixing device, according to the second embodiment of the present invention;

FIG. 4 is a sectional view illustrating the interior of a water/powdered milk mixing device, according to the third embodiment of the present invention;

FIG. 5 is a detailed view illustrating a structure coupling a powdered-milk storage container with a powdered-milk dispensing means of the water/powdered milk mixing device, according to the present invention;

FIG. 6 is a view illustrating an outlet control means of the water/powdered milk mixing device, according to the present invention, the outlet control means controlling a powdered-milk dispensing operation;

FIG. 7 is a block diagram showing the connection of respective components to a control unit for controlling the function of the water/powdered milk mixing device, according to an embodiment of the present invention; and

FIG. 8 is a block diagram showing the connection of respective components to a control unit for controlling the function of the water/powdered milk mixing device, according to another embodiment of the present invention.

### BEST MODE FOR CARRYING OUT THE INVENTION

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The above and other objects, features and advantages of the present invention will be more clearly understood from the following detailed description.

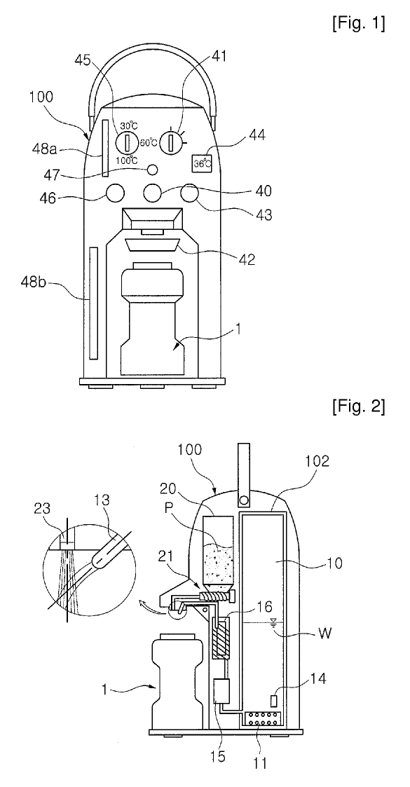

FIG. 1 is a front view showing the external appearance of a casing of a water/powdered milk mixing device, according to the first embodiment of the present invention, and FIG. 2 is a right side view showing the water/powdered milk mixing device.

As shown in FIGS. 1 and 2, the water/powdered milk mixing device for mixing water and powdered milk, according to the first embodiment of the present invention, includes one casing 100 having a water storage container 10 and a powdered-milk storage container 20. A water heating means 11 is provided to heat water W which is stored in the water storage container. The water/powdered milk mixing device includes the water heating means 11, a temperature sensor 14, and a control unit 50. The water storage container 10, which heats water to a temperature suitable for feeding a baby under the control of the control unit and stores the water, is installed in the casing 100. A powdered-milk dispensing means 21, which continuously supplies powdered milk P to a powdered-milk outlet 22, is mounted to the powdered-milk storage container 20. Meanwhile, a water supply pump 15 is provided on a water line 13 connecting the water storage container 10 to a water outlet 12. The powdered-milk outlet 22 and the water outlet 12 are provided on the outer portion of the casing 100 such that they are spaced apart from each other but are adjacent to each other. A sterilizing lamp 16 is mounted on the water line to sterilize water. A mixing switch 40 is provided to control the water supply pump 15, the powdered-milk dispensing means 21, and the On/Off operation of the sterilizing lamp 15.

The powdered-milk dispensing means 21 includes the control unit 50, a screw 24, and a drive motor 25. A milk concentration value (the mixing ratio of water to powdered milk) which is set by a user is input to the control unit 50. The control unit 50 controls the amount of powdered milk which is to be discharged depending on the amount of the dispensed water. The rotation amount of the screw 24 is varied in response to a control signal from the control unit 50. The drive motor 25 drives the screw 24. Such a construction allows the powdered-milk dispensing means 21 to dispense the proper amount of powdered milk according to the milk concentration (mixing ratio of water to powdered milk) which is set by a user. That is, the water/powdered milk mixing device of the present invention is provided with a concentration-control-switch 41 so that a user may change the milk concentration according to the state of health of the baby to be fed. A signal input by the concentration-control-switch 41 must be stored in the control unit. In this case, the control unit 50 controls the extent of rotation of the drive motor 25 driving the screw 24 so that the the powdered milk is dispensed in a constant amount, which is set by the concentration-control-switch 41. Thus, even if the desired amount of milk is changed, the milk can maintain a constant concentration.

According to the present invention, the concentration-control-switch 41 is provided as the means for controlling the mixing ratio of water to powdered milk. The concentration-control-switch 41 is constructed to have two or more stages. When a user selects one of the stages (the mixing ratio of water to powdered milk is determined), the rotating speed of the screw 24 per unit time, which corresponds to the mixing ratio, is changed. The input amount of the powdered milk is controlled while water is supplied at a constant speed, so that the concentration of the milk is controlled to be identical to the value set by the concentration-control-switch 41. That is, in the state where the water supply pump 15 is controlled so that the amount of water supplied per unit time is kept constant, the rotating speed of the powdered-milk dispensing screw 24 per unit time is variably controlled. Thus, only when the mixing switch 40, which is a Normal-OFF switch, is pressed, the water W and the powdered milk P are dispensed and mixed with each other while maintaining a constant concentration. Therefore, according to the operating time of the water/powdered milk mixing device, a desired amount of milk, such as 100 ml or 200 ml, can be obtained.

According to the present invention, the mixing switch 40 serves as a drive switch for driving the water supply pump 15 of the water line 13 and the drive motor 25 of the powdered-milk dispensing means 21. Further, the mixing switch 40 simultaneously serves as a switch for driving the sterilizing lamp 16 mounted on the water line.

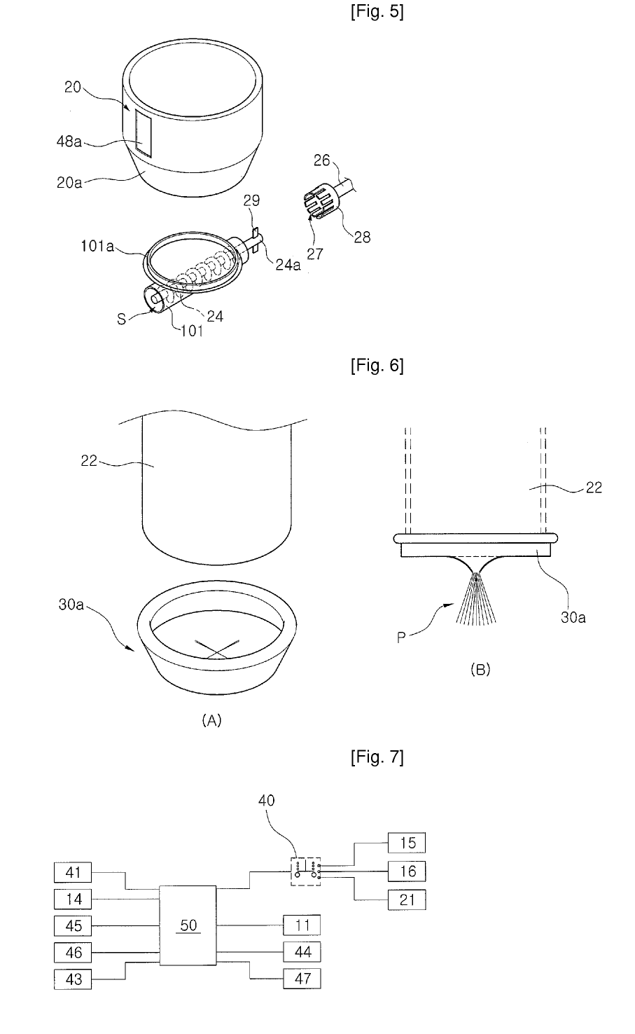

In the present invention, the powdered-milk dispensing means 21 is preferably constructed to be separated from the casing 100, thus allowing a cleaning operation to be easily performed. FIG. 5 shows the powdered-milk dispensing means, according to the preferred embodiment of the present invention, and shows the connection of the powdered-milk storage container 20 with the powdered-milk dispensing means 21. As shown in FIG. 5, the powdered-milk dispensing means 21 has the drive motor 25, a drive shaft 26, a contact part 28, the screw 24, and a screw housing 101. The contact part 28 has contact slits 27, and is mounted to one end of the drive shaft 26. The screw 24 has a contact piece 29 which is provided on an end of a shaft 24a of the screw 24 and is fitted into the contact slits 27. The screw housing 101 accommodates the screw 24 therein, and has a space S in which the powdered milk is moved by the rotation of the screw 24. Preferably, a coupling part 101a is provided on the screw housing 101 to couple the powdered-milk dispensing means 21 to the lower portion 20a of the powdered-milk storage container 20. Through such a construction, the powdered-milk storage container 20 and the powdered-milk dispensing means 21 may be disassembled from and assembled with the casing 100, thus cleaning the powdered-milk storage container 20, and also cleaning the powdered-milk dispensing screw 24 and the space S in the screw housing 101a, therefore enhancing sanitation.

According to the present invention, the powdered-milk storage container 20 preferably has the shape of a hopper which is generally known to those skilled in the art, thus allowing the powdered milk to be smoothly fed into the powdered-milk dispensing means.

Further, it is important that the water outlet 12 and the powdered-milk outlet 22 be independently arranged near each other.

If the powdered-milk supply line and the water supply line share the same line, the mixing passage may be contaminated and germs may propagate in the mixing passage. Especially when a common pipe is disposed in the casing 100, it is more difficult to clean. Thus, according to the present invention, the water line 13 and a powdered-milk dispensing pipe 23 do not share the same pipe in the casing 100, but have respective outlets 12 and 22, thus completely preventing the problem from occurring.

Moreover, the outlets 12 and 22 are disposed to be adjacent to each other, and are disposed such that the dispensing direction of the powdered milk intersects the dispensing direction of the water. Thus, after the water and the powdered milk are dispensed along the respective courses, the water and the powdered milk meet at the crossing position, so that the water and the powdered milk can be mixed well. The mixed water and powdered milk drop into a baby bottle 1 due to gravity, and collide with the bottom of the baby bottle, thus being secondarily mixed. Thus, the water and the powdered milk can be rapidly mixed with each other.

Therefore, according to the present invention, the proper arrangement of the water line 13 and the powdered-milk dispensing pipe 23, the continuous supply, and the falling energy can achieve a double stirring effect. Hence, even if the device does not have an additional stirring device, such as a motor, a sufficient stirring effect can be obtained.

The removal of the stirring device minimizes the weight and volume of the water/powdered milk mixing device, and provides a simple construction, thus increasing productivity.

According to one characteristic of the water/powdered milk mixing device of the present invention, an outlet control means 30 is preferably provided on the powdered-milk outlet 22 to open or close the outlet. If the powdered-milk outlet 22 is always open, the powdered milk may solidify, because the open outlet provides a path along which moisture present in the atmosphere enters the powdered-milk storage container. Further, because of vapor which is produced when warm milk is dispensed, the powdered milk covering the outlet may undesirably become sticky. Furthermore, the water/powdered milk mixing device must be easily carried. When the water/powdered milk mixing device is carried, the powdered milk remaining in the powdered-milk outlet 22 may undesirably drop. Therefore, the water/powdered milk mixing device is provided with the outlet control means for opening or closing the powdered-milk outlet, thus sufficiently solving the above-mentioned problems.

The outlet control means of the powdered-milk outlet may use a thin rubber film 30a, which is cut into a “+” shape or a “−” shape, as shown in FIG. 6. Further, a solenoid valve 30b may be applied as the outlet control means. The solenoid valve 30b is opened only when power is applied. Conversely, when power is cut off, the solenoid valve 30b is closed by the restoring force of a spring. Various outlet control means, such as an actuator controlled by a controller or an electronic valve, may be selectively applied as the outlet control means.

Preferably, an illumination lamp 42 for illuminating the position where the baby bottle 1 is placed and an illumination switch 43 for operating the illumination lamp are provided at predetermined positions on the casing 100. The illumination lamp allows the baby bottle 1 to be placed at the correct position under the water and powdered-milk outlets without turning on a room lamp at night, and allows the amount of milk in the baby bottle to be checked. Moreover, the illumination lamp may be used as a room lamp while the milk is fed to a baby.

According to the present invention, the water storage container 10 is installed in the casing 100 so that a predetermined amount of water can be dispensed by the water supply pump 15. In order to maintain the temperature of water stored in the water storage container 10, as shown in FIG. 2, a heat insulating layer 102 for preventing heat transfer may be further provided between the water storage container 10 and the casing 100. Since water heated to a temperature suitable for feeding a baby is stored in the water storage container 10, it is not necessary to heat water and the time spent on heating the water can be reduced.

In order to maintain the temperature (about 36° C. to 40° C.) suitable for feeding a baby, the temperature sensor 14 is provided in the water storage container 10 of the invention, and continuously measures the temperature of the water in the water storage container 10 and transmits the measured temperature to the control unit 50. The control unit 50 controls the water heating means 11 such that the water heating means 11 is operated or stopped depending on the variation in temperature of water. Preferably, a temperature display 44 is provided to display the temperature measured by the temperature sensor 14 to a user who is outside the casing 100, thus being highly convenient for the user.

Moreover, the present invention can provide the function of an electric kettle for boiling water, in addition to the function of the water/powdered milk mixing device. That is, it is preferable that a temperature control switch 45 be additionally provided in the water/powdered milk mixing device of the present invention, thus allowing a user to control the temperature of the water in the water storage container as desired. When a user desires to use the invention as an electric kettle as well as the water/powdered milk mixing device, a switch (water-supply only switch) must be provided so that the powdered-milk dispensing means 21 is not operated while water is discharged. The water-supply only switch 46 is constructed to control the water supply pump 15, and must be connected in parallel with the mixing switch 40 for mixing the water with the powdered milk.

Since the components, including the temperature sensor 14, the temperature display 44, the temperature control switch 45, he water-supply only switch 46, and the Normal-OFF type mixing switch 40, are widely known to those skilled in the art, a detailed description of the components will be omitted.

Meanwhile, since the feeding interval is generally short, the water storage container 10 is not easily contaminated. However, the temperature (about 36° C. to 40° C.) of the water, which is kept warm to be suitable for an optimum feeding condition, provides an environment where germs may rapidly propagate in the water. Thus, it is necessary to sterilize warm water dispensed from the water line 13 for supplying water. Therefore, according to the present invention, the water stored in the water storage container 10 is maintained at the feeding temperature, and the sterilizing lamp 16 is provided nearest to the water outlet 12 of the water line.

The water line 13 passes through the sterilizing lamp 16. Preferably, the sterilizing lamp 16 is installed at any one place in the casing where the water line passes, and it is necessary to maximize the contact area by spirally winding the water line 13 on a UV emitting part of the sterilizing lamp. Such a construction increases the UV exposure time in the sterilizing lamp 16, thus sufficiently sterilizing the water in the water line. Since the sterilizing lamp emits ultraviolet rays, the sterilizing lamp is preferably installed in the casing 100 in such a way as to be concealed.

Further, when the sterilizing lamp 16 is installed in the casing 100 in such a way as to be concealed, an operation indicating lamp 47 for indicating the operation of the sterilizing lamp may be mounted on the outer portion of the casing. Preferably, the operation indicating lamp has a function of indicating the malfunction of, or the replacement time for, the sterilizing lamp, under the control of the control unit 50.

FIG. 7 is a block diagram schematically showing the connection of the control unit 50 to the respective components, in the water/powdered milk mixing device of the present invention including the mixing switch 40, the concentration-control-switch 41, the water heating means 11, and the sterilizing lamp 16.

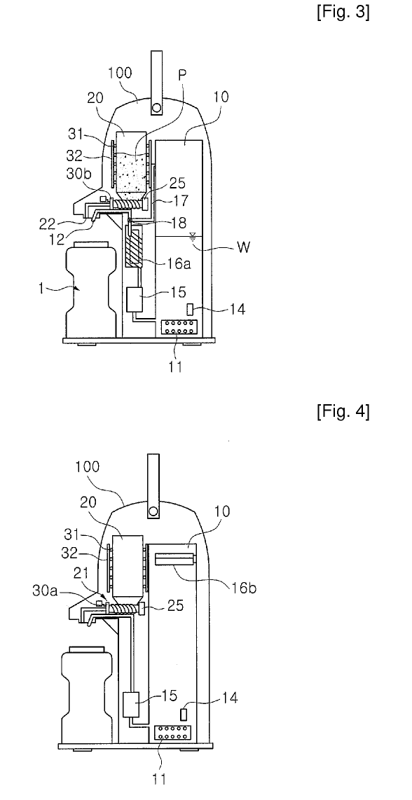

As shown in FIGS. 3 and 4, the water/powdered milk mixing device, which is further improved, further includes a powdered-milk heating means 31 for heating the powdered milk P stored in the powdered-milk storage container 20 to sterilize it.

The reason why the powdered-milk heating means 31 is provided on the outer portion of the powdered-milk storage container 20 is because Enterobacter sakazakii, which is a kind of colon bacillus, is reported to have been found in powdered-milk preparations, and thus it is necessary to sterilize the powdered milk as well as the water.

To this end, the powdered-milk storage container 20 is preferably made of a material having high heat conductivity. The powdered-milk heating means 31 is constructed to be in contact with the powdered-milk storage container 20. In order to prevent the powdered-milk heating means 31 from breaking or being damaged when the powdered-milk storage container 20 is disassembled or assembled, the powdered-milk heating means 31 is constructed to be supported by a support frame 32.

The powdered-milk heating means 31 is driven under the control of the control unit 50, and may comprise a heating wire.

As shown in FIG. 1, an indicating window 48a is mounted to the outer portion of the casing 10 in which the water storage container is installed, and indicates the level of the water in the water storage container. A measuring scale may be formed on the indicating window 48a to indicate the amount of water stored therein.

According to the present invention, the powdered-milk storage container 20 has a hopper-shaped body so that the powdered milk can easily drop, and is provided on the upper portion of the casing 100. Like the indicating window of the water storage container, an indicating window 48b may be mounted on the casing to indicate the amount of the powdered milk in the powdered-milk storage container.

As described above, the water/powdered-milk mixing device of the present invention has superior immediacy, sanitation, and productivity compared to the prior art, and in addition, has inventiveness in the aspect of convenience.

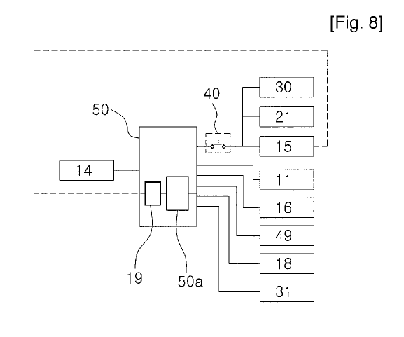

However, in order to enhance the convenience, the water/powdered milk mixing device of the present invention further includes an accumulation indicator 49 for indicating the accumulated amount of mixed milk, and a flow sensor 19 is further provided on the water line 13 to detect the amount of supplied water, and an accumulation calculator 50a for calculating the accumulated amount of mixed milk is further provided on the control unit 50. That is, the water/powdered milk mixing device, having the function of calculating the accumulated amount of mixed milk, calculates the amount of milk which has been produced in a predetermined period (e.g. one day) by the water/powdered milk mixing device of the present invention, using the control unit 50. The accumulation indicator 49, which is a display means, indicates the calculated accumulated amount to a user. Thereby, parents can confirm the amount of milk fed to a baby in one day, and can more precisely adjust the feeding amount, thus being helpful to the baby's health. FIG. 8 is a block diagram schematically showing the connection of the control unit to the respective components, in the water/powdered milk mixing device of the present invention including the accumulation display means and the powdered-milk heating means 31.

As shown in FIG. 3, the water/powdered milk mixing device according to the second embodiment of the present invention includes a casing 100. A water supply unit, having a water storage container 10 and a water supply pump 15, and a powdered-milk dispensing means 21, having a powdered-milk storage container 20 and a drive motor 25, are installed in the casing 100. When a mixing switch 40 is turned on, a drive signal is transmitted from a control unit 50 to the water supply unit and the powdered-milk dispensing means, so that the water supply unit and the powdered-milk dispensing means dispense water W and powdered milk P, respectively. The water/powdered milk mixing device is provided with a temperature sensor 14 and a water heating means 11 so as to maintain the temperature that is input to the control unit 50. In this case, a circulation line 17, which starts from the water storage container 10 and returns to the water storage container 10, passes through the water supply pump 15, and a sterilizing lamp 16a is mounted on the circulation line 17 to sterilize the water. When the water supply pump is operated by the control unit 50, the water stored in the water storage container is circulated in the circulation line and is sterilized.

The circulation line 17 includes a three-way valve 18 which is provided on a water line 13 located behind the water supply pump 15. The circulation line 17 passes through the three-way valve 18 to be connected to the water storage container 10. That is, the circulation line 17 is required for sterilization of the water using the sterilizing lamp 16a while the water stored in the water storage container 10 is periodically circulated under the control of the control unit 50. The three-way valve 18 is a solenoid valve which is controlled by the control unit 50. When the mixing switch 40 is turned on, the three-way valve is opened so that water passing through the water supply pump 15 flows to a water outlet 12. Conversely, when the water circulating operation is performed to sterilize the water, the three-way valve is opened so that water passing through the water supply pump 15 flows in the circulation line 17. The periodic sterilization of water using the circulation line 17 is achieved by winding the transparent-tube-type circulation line 17 around the sterilizing lamp 16a. Alternatively, the water may be periodically sterilized by providing an additional sterilizing space accommodating the sterilizing lamp 16a in the circulation line 17.

The second embodiment is invented for the following reasons. That is, according to the first embodiment, the sterilizing lamp is installed around a water discharge pipe, and sterilizes the water by radiating ultraviolet rays when the water is discharged. The method has the following advantages. First, the predetermined temperature at which water is maintained may be increased by the heat of the sterilizing lamp. Second, a final sterilizing operation is performed at a position adjacent to the water outlet, thus considerably enhancing the sanitation of water. However, the following additional problems may occur in the method of the first embodiment.

First, when the water is stored for a lengthy period of time while a predetermined temperature is maintained, such as when a user comes home back after a long trip, the number of germs is increased, so that it is impossible to completely sterilize water through instantaneous sterilization when the water is discharged. Second, since the sterilizing lamp must be a high output product which is capable of sterilizing water in a short period of time when the water passes through the water discharge pipe, the product may be expensive. Third, the method of installing the sterilizing lamp around the water discharge pipe is complex, so that the manufacturing cost is increased. Fourth, the sterilizing lamp achieves a sufficient sterilizing effect when electric power is supplied to the sterilizing lamp and a preheating period of 2 to 3 minutes has passed. Thus, in order to provide a sterilizing effect immediately when the water is discharged, the sterilizing lamp must always be turned on, so that the lifespan of the sterilizing lamp is shortened and electric power is wasted.

The second embodiment is different from the first embodiment in that the water stored in the water storage container 10 is continuously and repeatedly sterilized while the water periodically passes through the circulation line, thus solving the problems of the first embodiment.

The third embodiment of the present invention is a modification of the second embodiment, and provides another construction of continuously and periodically sterilizing the water in a water storage container 10. That is, as shown in FIG. 4, the water/powdered milk mixing device according to the third embodiment is constructed so that a sterilizing lamp 16b, lighted periodically by a control unit 50, is installed in the water storage container 10, instead of removing the circulation line 17 and the sterilizing lamp 16a from the water/powdered milk mixing device according to the second embodiment, thus keeping water stored in the water storage container 10 clean.

As described above, when the sterilizing lamp 16b is provided in the water storage container 10 to sterilize the water, the temperature of the stored water is increased due to the heat generated by the sterilizing lamp 16b, so that it is difficult to continuously maintain a water temperature suitable for feeding a baby. Thus, in the water/powdered milk mixing device according to the third embodiment of the present invention, it is important to design the control unit 50 such that the operation of a water heating means 11 can be selectively turned on or off, in consideration of the operating period of the sterilizing lamp 16b installed in the water storage container 10 and of the proper temperature of water.

Compared to the second embodiment, the third embodiment is problematic in that the heat generated by the sterilizing lamp may minutely affect the temperature of the water. However, the third embodiment achieves a periodic and repeated sterilizing operation, which is the object of the present invention, using a simpler mechanical construction, thus reducing the manufacturing cost of the device.

1. A water/powdered milk mixing device having at least one water storage container (10) and at least one powdered-milk storage container (20) in one casing (100), having water healing means (11) for heating water (W) stored in the water storage container, and mixing the water with powdered milk, wherein the water heating means (11) and a temperature sensor (14), controlled by a control unit (50), heat the water in the water storage container (10) to a temperature suitable for feeding a baby, powdered-milk dispensing means (21) is mounted to the powdered-milk storage container (20) to continuously dispense the powdered milk (P) to a powdered-milk outlet (22), a water supply pump (15) is provided on a water line (13) for connecting the water storage container (10) to a water outlet (12), the powdered-milk outlet (22) and the water outlet (12) are provided on an outer portion of the casing (100) such that the powdered-milk outlet and the water outlet are spaced apart from each other but are adjacent to each other, a sterilizing lamp is installed in the water line or the water storage container (10) to sterilize the water stored in the water storage container (10, and a mixing switch (40) is provided to control the ON/OFF operation of the water supply pump (15) and the powdered-milk dispensing means (21), thus allowing a user to determine a dispensed amount of mixed milk as desired, in the state where a constant mixing concentration is maintained when the water and the powdered milk are continuously mixed with each other.

2. The water/powdered milk mixing device according to claim 1, wherein the powdered-milk dispensing means (21) comprises a drive motor (25), the control unit controlling a rotating speed of the drive motor (25) of the powdered-milk dispensing means in response to at least one signal input through a concentration-control-switch (31) which is used to select and input a concentration of the mixed milk.

3. The water/powdered milk mixing device according to claim 1, wherein an illumination lamp (42) is mounted to the outer portion of the casing (100).

4. The water/powdered milk mixing device according to claim 1, wherein the water outlet and the powdered-milk outlet are spaced apart from each other but are adjacent to each other in such a way that dispensing paths of the water and the powdered milk, which are continuously dropped, cross each other, whereby the dispensed water and the dispensed powdered milk are primarily mixed with each other at a crossing position, and thereafter are secondarily mixed with each other when the water and the powdered milk are dropped to a bottom of a baby bottle.

5. The water/powdered milk mixing device according to claim 1, wherein the mixing switch (40) comprises a Normal-OFF type switch which applies electric power only when a user manipulates the switch so as to allow the user to determine a dispensed amount as desired.

6. The water/powdered milk mixing device according to claim 1, further comprising: powdered-milk heating means (31) mounted on an outer portion of the powdered-milk storage container (20), and healing the powdered milk (P) stored in the powdered-milk storage container (20) to sterilize the powdered milk.

7. The water/powdered milk mixing device according to claim 1, further comprising: outlet control means (30) mounted on a powdered-milk dispensing pipe (23) to open or close the powdered-milk outlet (22).

8. The water/powdered milk mixing device according to claim 1, further comprising: an accumulation indicator (49) for indicating an accumulated feeding amount for a predetermined period of time.

9. The water/powdered milk mixing device according to claim 6, wherein the powdered-milk heating means (31) surrounds an outer portion of the powdered-milk storage container (20), and is installed in the casing (100) while being supported by a cylindrical support frame (32), the powdered-milk storage container (20) is constructed such that the powdered-milk storage container is separated from the casing (100), together with the powdered-milk dispensing means (21), and a coupling part (101a) is provided on a screw housing (101) of the powdered-milk dispensing means to be coupled to a lower portion (20a) of the powdered-milk storage container (20), thus allowing the powdered-milk storage container to be assembled or disassembled using the coupling part, thereby enabling easy cleaning of an interior of the powdered-milk storage container (20).

10. The water/powdered milk mixing device according to claim 1, wherein a circulation line (17), starting from the water storage container (10) and returning to the water storage container (10), passes through the water supply pump (15), and a sterilizing lamp (16a) is mounted on the circulation line (17) to sterilize the water, whereby the water, stored in the water storage container, is circulated in the circulation line by the water supply pump operated under control of the control unit (50), and is sterilized.

11. The water/powdered milk mixing device according to claim 1, wherein a sterilizing lamp is installed in the water line or the water storage container (10) to sterilize the water stored in the water storage container (10), and is lighted periodically under control of the control unit (50), thus sterilizing the water in the water storage container (10).

12. The water/powdered milk mixing device according to claim 1, further comprising: a temperature control switch (45) provided on the casing (100) to allow a user to control temperature of the water in the water storage container as desired: and a water-supply only switch for preventing the powdered-milk dispensing means (21) from being operated while the water is dispensed.

13. The water/powdered milk mixing device according to claim 2, further comprising: outlet control means (30) mounted on a powdered-milk dispensing pipe (23) to open or close the powdered-milk outlet (22).

14. The water/powdered milk mixing device according to claim 2, further comprising: an accumulation indicator (49) for indicating an accumulated feeding amount for a predetermined period of time.

15. The water/powdered milk mixing device according to claim 2, further comprising: a temperature control switch (45) provided on the casing (100) to allow a user to control temperature of the water in the water storage container as desired: and a water-supply only switch for preventing the powdered-milk dispensing means (21) from being operated while the water is dispensed.

16. The water/powdered milk mixing device according to claim 10, further comprising: a temperature control switch (45) provided on the casing (100) to allow a user to control temperature of the water in the water storage container as desired: and a water-supply only switch for preventing the powdered-milk dispensing means (21) from being operated while the water is dispensed.

17. The water/powdered milk mixing device according to claim 11, further comprising: a temperature control switch (45) provided on the casing (100) to allow a user to control temperature of the water in the water storage container as desired: and a water-supply only switch for preventing the powdered-milk dispensing means (21) from being operated while the water is dispensed.
